(19) United States
(12) Patent Application Publication
(10) Pub. No.: US 2007/0092088 A1
(43) Pub. Date: Apr. 26, 2007

(54) Wireless plug-in speaker unit

(76) Inventor: Fong-Min Chang, Milpitas, CA (US)

Correspondence Address: DALE F. REGELMAN, LAW OFFICE OF DALE F. REGELMAN, P.C., 4231 SOUTH FREMONT AVENUE, TUCSON, AZ, 85714, US

(21) Appl. No.: 11/259,966

(22) Filed: Oct. 26, 2005

(51) Int. Cl. H04B 5/00; H04R 1/02

(52) U.S. Cl. 381/79; 381/394

(57) ABSTRACT

A wireless speaker assembly is disclosed. The wireless speaker assembly comprises a housing and an electrical plug comprising one or more prongs, where those one or more prongs can be disposed within the housing. The wireless speaker assembly further comprises an AC adapter interconnected to the electrical plug, where that AC adapter can convert AC power to DC power. The wireless speaker assembly further comprises a receiver circuit disposed within the housing and an interconnected antenna disposed within said housing, where the antenna in combination with the receiver circuit can receive Bluetooth compliant wireless signals. The wireless speaker assembly further comprises at least one speaker disposed within the housing, where the at least one speaker receives an audio signal produced by the receiver circuit. Applicant's wireless speaker assembly does not comprise any wires or cables extending outwardly from the housing.

### FIELD OF THE INVENTION

This invention relates to a wireless speaker apparatus disposed in a housing that can be easily interconnected to a standard wall outlet.

### BACKGROUND OF INVENTION

Conventional wireless speaker devices comprise a large space for batteries and/or for storing an external power cable. Such prior art devices are large and heavy. In addition, such operation of such prior art devices is inconvenient and necessarily requires continuous battery drainage during wireless operation, or routing of the power cable during battery-less operation. Furthermore, such prior art devices must be carefully located to prevent a fall, and to route the power cable so as not comprise an obstruction. Such devices are not really “plug-and-play” devices because of the time required to locate proper batteries, install the batteries, and find a proper location for the unit.

What is needed is a wireless apparatus that can be plugged into a standard wall outlet, and that does not comprise any external cabling or wires.

### SUMMARY OF THE INVENTION

Applicant's invention comprises a wireless speaker assembly. Applicant's wireless speaker assembly comprises a housing and an electrical plug comprising one or more prongs, where those one or more prongs can be disposed within the housing. The wireless speaker assembly further comprises an AC adapter interconnected to the electrical plug, where that AC adapter can convert AC power to DC power.

The wireless speaker assembly further comprises a receiver circuit disposed within the housing and an antenna disposed within said housing, where the antenna in combination with the receiver circuit can receive signals having a frequency of about 900 MHz. The wireless speaker assembly further comprises at least one speaker disposed within the housing, where the at least one speaker receives an audio signal produced by the receiver circuit. Applicant's wireless speaker assembly does not comprise any wires or cables extending outwardly from the housing.

### BRIEF DESCRIPTION OF THE DRAWINGS

The invention will be better understood from a reading of the following detailed description taken in conjunction with the drawings in which like reference designators are used to designate like elements, and in which:

FIG. 1 is a perspective view of the front of Applicant's wireless speaker apparatus;

FIG. 2 is a perspective view of the rear of Applicant's wireless speaker apparatus;

FIG. 3 is a sectional view of one embodiment of Applicant's wireless speaker apparatus;

FIG. 4 is block diagram showing the components of Applicant's wireless speaker apparatus;

FIG. 5 is a perspective view of Applicant's speaker apparatus interconnected to a standard electrical socket.

### DETAILED DESCRIPTION OF THE PREFERRED EMBODIMENTS

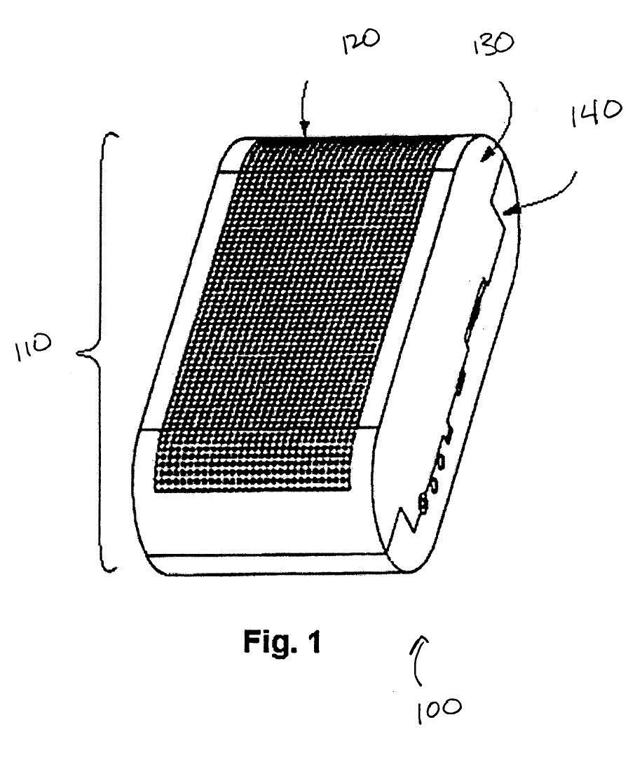

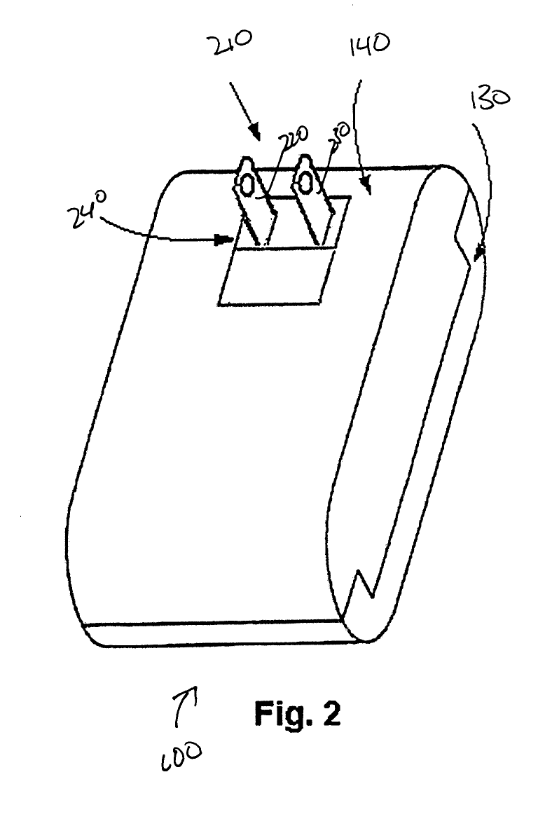

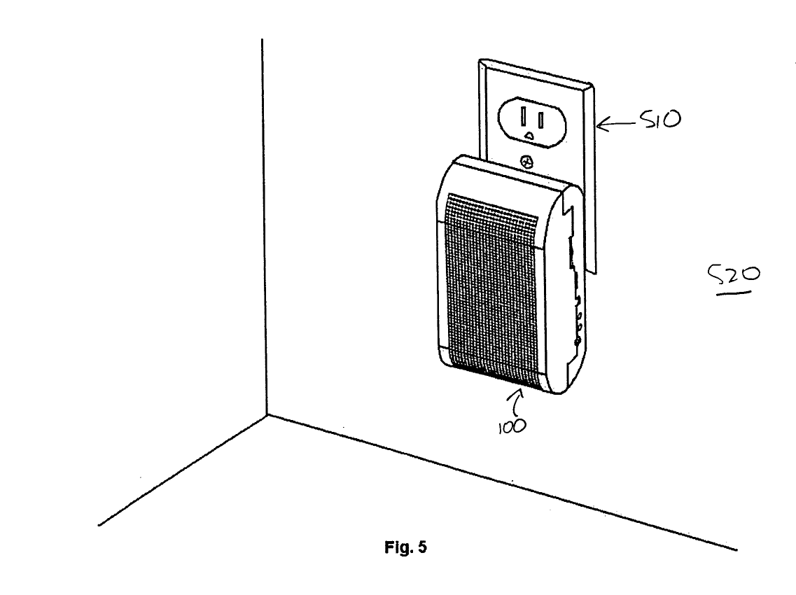

Referring to the illustrations, like numerals correspond to like parts depicted in the Figures. FIGS. 1 and 2 show apparatus 100 which includes housing 110. Housing 110 further comprises grille 120, front housing 130, and rear housing 140. FIG. 5 shows apparatus 100 plugged into a wall outlet 510, where outlet 5 10 is disposed within wall 520.

In the illustrated embodiment of FIG. 2, apparatus 100 comprises electrical plug 210 which comprises first prong 220 and second prong 230. As those skilled in the art will appreciate, prongs 220 and 230 can be removeably inserted into a standard, 2-prong, electrical outlet. In other embodiments, electrical plug 210 comprises more that 2 prongs. In still other embodiments, electrical plug 210 comprises a single prong, wherein that single prong is configured to be removeably insertable into a cigarette lighter assembly disposed in a vehicle.

The one or more prongs of the electrical plug 210 can be configured to accommodate a wide variety of outlet plug configurations. In certain embodiments, electrical plug 210 is designed for an input power of about 110 volts and about 60 hertz. In still other embodiments, electrical plug 210 is designed for an input power of about 220 volts at about 50 hertz. In other embodiments, electrical plug 210 is designed for an input power of 12 volts DC.

Electrical outlet plug 210 comprises a power input portion of Applicant's apparatus. In addition, electrical plug 210, in combination with a compatible electrical outlet and structure supporting that electrical outlet, such as for example outlet 510 and wall 520, comprises the physical support, i.e. the base or stand, for Applicant's wireless speaker assembly.

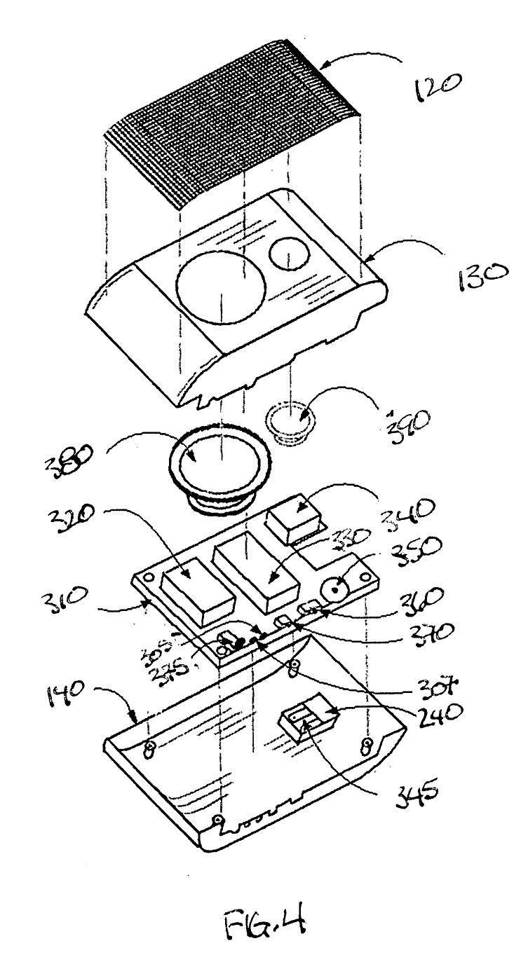

In certain embodiments, apparatus 100 further comprises swivel joint 240. When swivel joint 240 is placed in a first orientation shown in FIG. 4, plug 210 is disposed within rear housing 140. When swivel joint 240 is rotated about 90 degrees from the first orientation to a second orientation shown in FIG. 2, prongs 220 and 230 extend outwardly from rear housing 140.

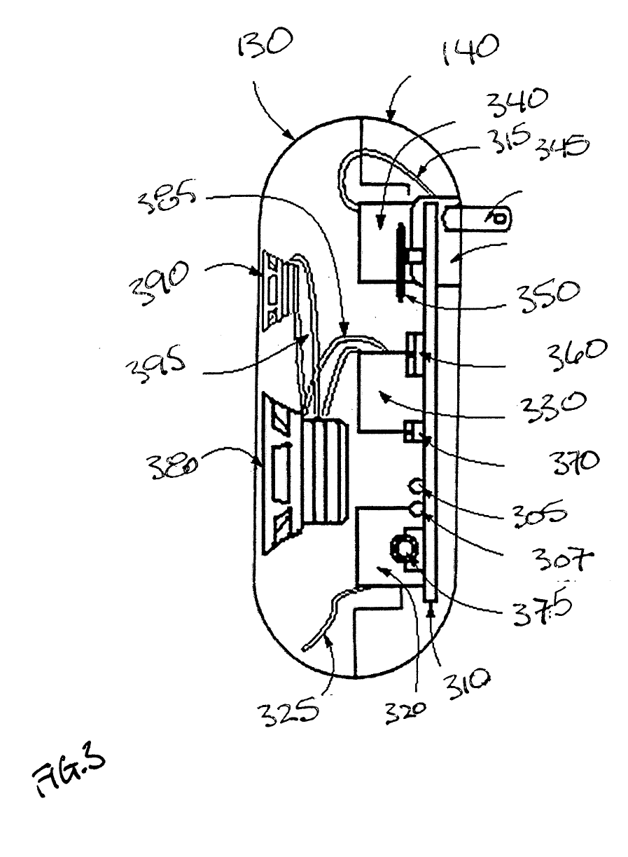

Referring now to FIGS. 3 and 4, Applicant's speaker assembly 100 comprises at least one speaker 380. In certain embodiments, speaker assembly 100 further comprises a second speaker 390. In certain embodiments, speaker 390 comprises a “tweeter” to produce an upper range of audio frequencies thereby giving apparatus 100 a high frequency response. In certain embodiments, speaker 380 comprises a “mid-range” to produce mid to low range of audio frequencies thereby giving apparatus 100 a mid to low frequency response. Audio signal communication links 385 interconnected amplification circuit 330 and speaker 380. Audio signal communication links 395 interconnect speaker 380 and speaker 390, and provide the signal from amplification circuit 330 to speaker 390 via speaker 380.

Circuit board 310 comprises receiver circuit 320, amplification circuit 330, AC adaptor 340, volume and on/off switch 350, frequency channel switch 360, audio channel switch 370, power indicator LED 305, standby LED 307, and audio line-out plug 375.

In certain embodiments, receiver circuit 320 comprises a device described in U.S. Pat. No. 5,870,005, which is hereby incorporated herein. Receiver circuit 320 in combination with antenna 325 receives radio frequency signals emitted by a local area wireless transmission system. In certain embodiments, Applicant's speaker assembly is capable of receiving wireless audio signals having a frequency of about 900 Mhz.

In certain embodiments, Applicant's speaker assembly is capable of receiving Bluetooth-compliant emissions at about 2.4 GHz. In other embodiments, Applicant's receiver circuit 320 can receive wireless signals that are IEEE Standard 802.11 compliant. Embodiments of receiver circuit 320 compliant with the 802.11b and 802.11g standards receive signals transmitted at 2.4 GHz. Embodiments of receiver circuit 320 that are compliant with the 802.11a standard receive signals at 5 GHz.

Embodiments of receiver circuit 320 that are 802.11a and/or 802.11g compliant are capable of receiving and processing audio data at enhanced data rates by utilizing orthogonal frequency-division multiplexing (OFDM). These embodiments of Applicant's receiver circuit 320 can receive and process data up to about 54 megabits per second. Embodiments of receiver circuit that are 802.11b compliant utilize Complementary Code Keying technology, and are capable of receiving and processing data up to about 11 megabits per second.

In addition, in certain 802.11b compliant embodiments receiver circuit 320 can receive on any of three bands, or onto dozens of channels and frequency hop rapidly between them. Using such frequency hopping, Applicant's wireless speaker is much less sensitive to interference.

The processed signal from the receiver circuit 320 is provided to amplification circuit 330 via one or more communication links disposed on circuit board 310. In certain embodiments, those one or more communication links comprise copper traces disposed on circuit board 310. Amplification circuit 330 enhances the amplitude of the signal, and then provides that enhanced signal to speaker 380. In certain embodiments, amplification circuit 330 comprises a Class-D amplifier device sold in commerce by Microelectronic Corp. under the designation TMPA401DM.

AC adaptor 340 is connected to electrical outlet plug 210 through leads 315. AC adaptor 340 transforms the power supplied by the outlet receptacles of usual use (110V to 220V alternating current) into that used in the receiver circuit 320 and the amplification circuit 330. In certain embodiments, AC adaptor transforms 110V 60 hertz AC to 6V DC. In certain embodiments, AC adaptor transforms 110V 60 hertz AC to 12V DC. In certain embodiments, AC adapter 340 comprises a power conversion integrated circuit sold in commerce by Power Integrations, Inc. under the designation TOP243Y.

Volume and on/off switch 350 is interconnected with amplification circuit 330 and speaker 380. Switch 350 can adjust, i.e. increase or decrease, the amplitude of the signals provided by amplification circuit 330, and to turn on or off power to circuit board 310.

Frequency channel switch 360 can adjust receiver circuit 320 to operate on, but not limited to, four different preset frequencies allowing Applicant's wireless speaker assembly to operate simultaneously other wireless devices without interference. Audio channel switch 370 adjusts receiver circuit 320 to output an either a left channel, a right channel, or mono, audio signals to amplification circuit 330.

Power LED 305 emits visible light when speaker assembly 100 is on and operating. Standby LED 307 emits visible light when apparatus 100 is on but receiver circuit 320 is not receiving emitted signals. LED 307 does not emit visible light when apparatus 100 is powered off, or when apparatus 100 is powered on and receiver circuit 320 is receiving signals. Audio line-out plug 375 provides signals received from receiver circuit 320 to external audio devices such as, but not limited to, home audio amplifiers, headphones or amplified speaker.

While the preferred embodiments of the present invention have been illustrated in detail, it should be apparent that modifications and adaptations to those embodiments may occur to one skilled in the art without departing from the scope of the present invention as set forth in the following claims.

I claim:

1. A wireless speaker assembly, comprising:
a housing;
an electrical plug comprising one or more prongs, wherein said one or more prongs can be stored within said housing;
an AC adapter interconnected to said electrical plug, wherein said AC adapter converts AC power to DC power;
a receiver circuit disposed within said housing;
an antenna disposed within said housing;
wherein said antenna in combination with said receiver circuit can receive Blue Tooth compliant signals;
a first speaker disposed within said housing, wherein said first speaker receives an audio signal produced by said receiver circuit;
wherein said wireless speaker assembly does not comprise any wires or cables extending outwardly from said housing.

2. The wireless speaker assembly of claim 1, further comprising:
an amplification circuit, wherein said amplification circuit receives audio signals from said receiver circuit, and wherein said amplification circuit can adjust the amplitude of said audio signals;
one or more first audio signal communication links interconnecting said amplification circuit and said first speaker.

3. The wireless speaker assembly of claim 2, further comprising:
a second speaker;
one or more second audio signal communication links interconnected said second speaker and said first speaker.

4. The wireless speaker assembly of claim 3, wherein said first speaker comprises a tweeter, and wherein said second speaker comprises a mid range speaker.

5. The wireless speaker assembly of claim 1, wherein said receiver circuit can receive and process wireless signals compliant with IEEE standard 802.11a, wherein those wireless signals comprise a frequency of about 5 GHz.

6. The wireless speaker assembly of claim 5, wherein said receiver circuit can receive and process signals at a rate up to about 54 megabits per second.

7. The wireless speaker assembly of claim 6, wherein said receiver circuit utilizes orthogonal frequency-division multiplexing to receive and process wireless signals.

8. The wireless speaker assembly of claim 1, wherein said receiver circuit can receive and process wireless signals compliant with IEEE standard 802.11b, wherein those wireless signals comprise a frequency of about 2.4 GHz.

9. The wireless speaker assembly of claim 8, wherein said receiver circuit can receive and process signals at a rate up to about 11 megabits per second.

10. The wireless speaker assembly of claim 9, wherein said receiver circuit utilizes Complementary Code Keying to receive and process wireless signals.

11. The wireless speaker assembly of claim 1, wherein said receiver circuit can receive and process wireless signals compliant with EEE standard 802.11g, wherein those wireless signals comprise a frequency of about 5 GHz.

12. The wireless speaker assembly of claim 11, wherein said receiver circuit can receive and process signals at a rate up to about 54 megabits per second.

13. The wireless speaker assembly of claim 12, wherein said receiver circuit utilizes orthogonal frequency-division multiplexing to receive and process wireless signals.

14. The wireless speaker assembly of claim 1, wherein said AC adapter transforms 110 volt 60 hertz AC to 6 volt DC.

15. The wireless speaker assembly of claim 14, wherein said AC adapter transforms 220 to 240 volts at 50 hertz AC to 6 volt DC.
